(19) United States
(12) Patent Application Publication
(10) Pub. No.: US 2012/0262067 A1
(43) Pub. Date: Oct. 18, 2012

(54) BATTERY OPERATED DEVICES

(75) Inventors: Siu Chung Tam, Tsuen Wan (HK); Ka Wai Eric Cheng, Hung Hom (HK); Yanjie Bao, Hung Hom (HK); Daohong Wang, Hung Hom (HK); Wai Pang Yau, Tsuen Wan (HK)

(73) Assignee: ECOTECH ENVIRONMENTAL TECHNOLOGY LTD., Tsuen Wan, New Territories (HK)

(21) Appl. No.: 13/517,080

(22) PCT Filed: Jan. 5, 2011
(86) PCT No.: PCT/IB2011/050033

§ 371 Date: Jun. 19, 2012

Related U.S. Application Data
(60) Provisional application No. 61/292,384, filed on Jan. 5, 2010.

(51) Int. Cl. H05B 37/02

(52) U.S. Cl. 315/119; 315/246

(57) ABSTRACT

A battery operated device such as a road stud comprises a micro-controller, a battery, and a light source. The micro-controller is configured to operate the battery to provide a train of power pulses to the light source, and each power pulse has a characteristic pulse period and a characteristic duty cycle comprising an on-cycle and an off-cycle. The micro-controller is turned on during the on-cycle and turned into a power saving or sleep mode during the off cycle. Setting the micro-controller into the power saving or sleep mode during the off cycle of the power pulse means substantial battery power saved to extend the operation time per charging of the battery.

### FIELD OF THE INVENTION

The present invention relates to battery powered devices, and more particularly to road studs with a battery operated light source. More specifically, although not solely limited thereto, the present invention relates to micro-controller operated road studs with a battery operated light source. The present invention also relates to power saving arrangements and schemes for battery powered micro-controller operated devices and devices incorporating same. This invention also relates to schemes for extending battery life and battery operated device incorporates same.

### BACKGROUND OF THE INVENTION

Power management is important in many battery powered devices, such as battery powered micro-controller operated devices. For example, autonomous remote or wireless devices which require electrical power to operate but have no access to mains power are dependent on the availability of battery power. The operating life of such devices is therefore critically determined by the operating life of the battery, especially when the device is hermetically sealed for outdoor use. Examples of such devices include remote sensors, underwater or submarine devices, remote telecommunications devices, and road studs.

Arrangements are known to have been employed to extend the operating life of such devices. For example, re-chargeable batteries and solar panels for recharging rechargeable batteries have been used in remote or wireless devices to extend battery and device operating life. Examples of such devices in the form of solar powered road studs have been disclosed in WO0142567A1 and WO2005/104799A2.

Road studs are mounted on roads to help delineate driving lanes in the dark. Conventionally, road studs are mounted with light reflecting cat-eye stones. However, road studs having battery lighting and solar power charging have also become viable and more popular.

However, as the size and costs of such devices often limit the size of the solar panels in such devices, the energy available for battery charging is still limited and improved power management schemes such as power saving schemes are therefore still desirable. Furthermore, as the operating life of a rechargeable life is to a large extent dependent on the number or charging and discharging cycles, improved battery charging schemes are also desirable.

### SUMMARY OF THE INVENTION

According to the present invention, there is provided a battery operated device such as a road stud, comprising a micro-controller (also known as micro-controller unit, or MCU), a battery and a light source; wherein the micro-controller is configured to operate the battery to provide a train of power pulses to the light source, and each power pulse has a characteristic pulse period and a characteristic duty cycle comprising an on-cycle and an off-cycle; characterized in that, the micro-controller is turned on during the on-cycle and turned into a power saving or sleep mode during the off-cycle.

Setting the MCU into a sleep mode during the off-cycle of the power pulse means substantial battery power saving to extend the operation time per charging of the battery.

The micro-controller may be configured to operate the road stud in different operation modes, and to vary the pulse period or pulse frequency and/or the duty cycle of the power pulses depending on the operation modes. This provides more flexible power management according to practical requirements.

For example, the different operation modes may include a light emitting mode during which the light source is operated to emit light for guiding road users and a hibernation mode during which the light source is non-light emitting.

For example, the micro-controller may be configured to operate the light source by a train of pulse width modulated (PWM) pulses. PWM pulses comprise non- or low energy containing periods, thereby saving battery power.

The power pulse may have a frequency between 50 to 200 Hertz, preferably between 50 to 120 Hertz, and more preferably at or below 100 Hertz. It is appreciated that the eyes of typically road users would not be able to detect blinking at a frequency above 50 Hz. A frequency range of 50 to 120 Hz, preferably at about 100 Hz, provides a good balance of non-blinking and energy saving.

The ratio between the duration of the on-cycle to entire pulse period, otherwise known as duty cycle, is less than 20%, preferably less than 10%, and preferably at or below 5%. Such a low duty cycle provides good power saving while providing the same a similar luminance perception to a user of substantially 100% duty cycle.

According to another aspect of the invention, there is provided a battery operated device such as a road stud comprising a micro-controller and a light source, wherein the micro-controller is configured to wake up and sleep at regular intervals, and wherein the wake up and sleep durations are different according to the operating modes of the road stud, the operating modes including an illumination mode or light-emitting mode during which the light source is turned on until a turn-off event occurs and a hibernation mode during which the light source is turned off until a turn-on event occurs.

Selecting different wake up and sleep intervals according to the operation modes of the road stud facilitates more flexible power management because the power requirements are different during the different operation modes.

For example, the intervals between wake ups of the micro-controller are longer for the hibernation mode and shorter for the light-emitting mode, because it can be expected that wake-up events will occur much less frequently during the hibernation mode when there is no need to provide lighted road stud guidance while wake-up events will occur during the light-emitting mode when the MCU will need to deliver on-pulses.

According to a further aspect of the present invention, there is provided a battery operated road stud comprising a micro-controller, a re-chargeable battery, a solar panel for charging the re-chargeable battery and a light source; wherein the micro-controller is configured to turn off the light source when the output level of the solar panel is above the predetermined threshold for a predetermined duration, and to turn on the light source when the output level of the solar panel is below the predetermined threshold for a predetermined duration.

For example, the predetermined duration may correspond to the durations of typical transient events, and repeated sampling of the output level of the solar panel may be taken during the predetermined duration to confirm a change in ambient conditions and mitigate transient influence.

According to yet another aspect of the present invention, there is provided a battery operated device such as a road stud comprising a micro-controller, a re-chargeable battery, a solar panel for charging the re-chargeable battery and a light source; wherein the micro-controller is configured to begin or not to begin charging the battery depending on whether the battery capacity is below or above a predetermined battery capacity and whether the output of the solar panel exceeds a predetermined solar output threshold for a predetermined time. Such a charging scheme reduces the number of unnecessary charging cycles to extend battery life and the predetermined battery capacity may be selected according to the number of reserve days the battery could operate without charging. A 50% battery capacity is selected on practical trial.

### BRIEF DESCRIPTION OF DRAWINGS

Embodiments of the present invention will be explained below by way of example and with reference to the accompanying drawings or figures, in which:-

FIG. 1 is a schematic diagram depicting a road stud according to an embodiment of the present invention,

FIG. 2 is an exemplary circuit diagram depicting in more detail the schematic diagram of FIG. 1,

FIG. 3 is a flow chart depicting exemplary operations of the exemplary road stud of FIG. 1,

FIG. 4 is a flow chart depicting decision schemes on exemplary operation illumination modes of the road stud of FIG. 1,

FIGS. 5 and 6 are exemplary timing diagrams showing operating modes of the road stud and corresponding operation states of the micro-controller,

FIG. 7 is a flow chart depicting decision schemes on exemplary operation battery charging modes of the road stud of FIG. 1,

FIG. 8 is a logic table for determining the mode of operation of the stud, and

FIG. 9 is a logic table for determining whether to begin battery charging.

### DESCRIPTION OF EXEMPLARY EMBODIMENTS

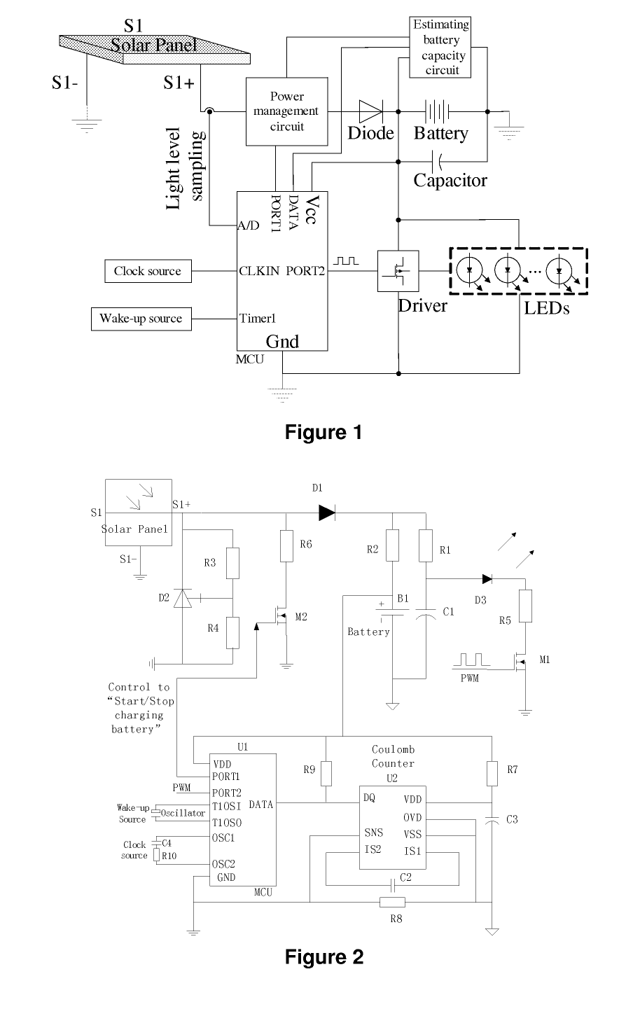

A schematic diagram of a road stud of FIG. 1 as an example of a battery operated device comprises a light source as an example of a major power consuming component, a rechargeable battery, a solar panel as an example of a solar cell and a micro-controller (MCU) as an example of a general purpose controller. The light source comprises a plurality of light emitting diodes. Light emitting diode (LED) is preferred because of its small size, robustness, long operating life and high energy conversion efficiency. In addition, the availability of LED in different colors is also ideal for traffic signal applications. In general, a higher voltage, typically 3.2V, is required to drive white or blue LED while a lower voltage, typically 2.0V, is required to drive LED of other colors.

A solar panel of 0.24-0.5 W at 2-5.5V output is used in the road stud as an example source of renewable energy for battery charging. The solar panel is made of mono-crystalline silicon photovoltaic (PV) material or other appropriate PV materials. However, because of the size of a road stud and the costs of solar panels, the size of a solar panel for use in a road stud is limited to the footprint of the stud. A nickel metal hydride (NiMH) battery as an example of a rechargeable battery is used in the road stud circuit because of its resilience to over-charging when compared, for example, to lithium ion batteries. This over-charging resilience is beneficial for achieving a longer battery life in conditions where the available battery charging power is somewhat unpredictable and unstable.

The power supply source comprises an electrolytic capacitor connected in parallel with the re-chargeable battery. An electrolytic capacitor is selected because it has a high power density and can withstand high charging and discharging rates. The combination of the re-chargeable battery and the electrolytic capacitor operates as a power buffer or damping against power transients such as current surges to protect the battery.

In order to operate the LED light source to emit light of an acceptable luminous level as perceived by a viewer while maintaining lower power consumption, the LEDs are driven by current pulses, rather than a ripple-free direct current. The current pulses are generated by the micro-controller in the form of pulse width modulated (PWM) pulses, and each pulse is characterized by a characteristic pulse period or pulse frequency and a characteristic duty cycle comprising an on-cycle and an off-cycle. The pulse period or pulse frequency and duty cycle are varied during different operation modes of the road stud in a manner to be explained in more detail below.

The battery is charged by current generated by the solar panel and charging of the battery is controlled by the micro-controller via a power management circuit. The power management circuit is connected between the solar panel and the battery and its operation is controlled by the micro-controller. The micro-controller includes a clock source and is also connected to wake-up source. The wake-up source is connected to the micro-controller to alert the micro-controller when a waking-up event occurs. In addition, an analogue-to-digital (A/D) port of the micro-controller is connected to the output of the solar panel for detecting the instantaneous voltage output of the solar panel. The instantaneous solar panel output provides energy as well as useful information on the ambient and could be used to determine the mode of operation of the road stud and mode of charging.

As shown in the exemplary circuit diagram of FIG. 2, a voltage regulator, comprising a voltage limiting diode D2 and voltage dividers R3, R4, is connected to the positive output terminal of the solar panel. The positive terminal of the solar panel is also connected to the positive terminal of the battery via a serial connection of a reverse blocking diode D1 and a resistor R2. This voltage regulator is provided to adjust the output voltage of the solar panel and to limit the battery voltage to below an acceptable level.

The power supply source to the LED comprises parallel connection of first and second branches. The first branch comprises a resistor R2 connected to the positive terminal of a battery B1. The second branch comprises a resistor R1 connected to a positive terminal of an electrolytic capacitor C1. The terminals of R1 and R2 which are not connected with either the battery or the electrolytic capacitor are connected with the cathode of the reverse current blocking diode D1. Power supply to the LED is tapped from the power supply terminal of R1 which is connected with the electrolytic capacitor. The LED is connected with its anode connected to the positive power supply terminal of R1 and with cathode connected to a resistor R5. The other terminal of the resistor R5 is connected to an input terminal of a switching MOSFET M1. The control or gate terminal of M1 is connected to the MCU for switching control. When the gate control is on, the MOSFET M1 is switched on and current will pass from the battery to the LED. On the other hand, when the MOSFET switch is turned off, the MOSFET switch will become a high impedance switching element and no light will be emitted by the LED.

The power management circuit also comprises a Coulomb counter for monitoring the capacity of the battery, and one input of the Coulomb counter is connected to the positive battery terminal. The power management circuit also comprises a power draining path which is arranged to drain the power generated by the solar panel to ground when there is no need to charge the battery. This power draining path is connected between the positive output terminal of the solar panel and ground, between positive output terminal of the solar panel and the diode D1, and comprises a serial connection of a resistor R6 and a MOSFET switch M2 operable by the micro-controller. The micro-controller is configured to turn the MOSFET switch M2 on to drain the output power of the solar panel to ground when there is no need to charge the battery, and to turn off the MOSFET to permit current flow from the solar panel output to the battery.

The wake-up source comprises an internal watchdog timer (WDT) and an external timer (Timer1). The Watchdog timer (WDT) is a free running on-chip oscillator which does not require any external components. Thus, the WDT will run, even if the external clock source connected between OSC1 and OSC2 pins of the MCU has stopped during the sleep period of MCU. A WDT time-out can cause the MCU to wake up and continue with normal operation. Outputs of the WDT and Timer1 are connected to a multiplexer, which would send out a wake-up alert whenever one of the WDT or Timer1 generates a wake-up signal.

The WDT is configured to have a nominal time-out period of 18 ms. If a longer time-out period is desired, a postscaler with a ratio of up to 1:128 can be assigned to the WDT under software control. Accordingly, a time-out period up to 18 ms*128=2.3 seconds can be realized. In the present solar road stud, the internal watchdog timer (WDT) of the MCU is set at 18 ms, and WDT with postscaler (1:2:4:8:16:32:64:128) can be configured as a 18 ms, 36 ms, 72 ms, 144 ms, 288 ms, 576 ms, 1.15 s, and 2.3 s timer.

Timer1 is clocked by an external oscillator of 32.768 kHz and is connected to a pre-scaler to form a 16-bit timer. A sleep timer based on a 16-bit timer and a prescaler (1:2:4:8) can operate over a range of 30.5 μs (1*2°*1/32768=30.5 μs) to 16 s (8* 2¹⁶*1/32768=16 s). Therefore, a precise control of wake-up timer over a wide range of selectable intervals can be accurately obtained with an external crystal oscillator and a prescaler.

If Timer1 is selected as the wake-up source, an external device or circuit, connected to the MCU's prescaler (1,2,4,8), such as an external crystal oscillator, is needed. In the case, a time-out period in excess of 2.3 seconds is chosen, and the external socillator provides the fundamental time constant before pre-scaling.

### Operation Modes of the Road Stud

The road stud of FIG. 1 is configured to operate in two modes, namely, a light emitting mode and a hibernation mode. The road stud will be in the light emitting mode when the ambient luminance level has dropped to below a level which would adversely affect on-road visibility. The road stud will be in the hibernation mode when the ambient luminance level is above a threshold level when the on-road visibility is so good that there is no need for road stud guidance. The light emitting mode and the hibernation mode are referred to as the night and day operation modes respectively below for easy reference.

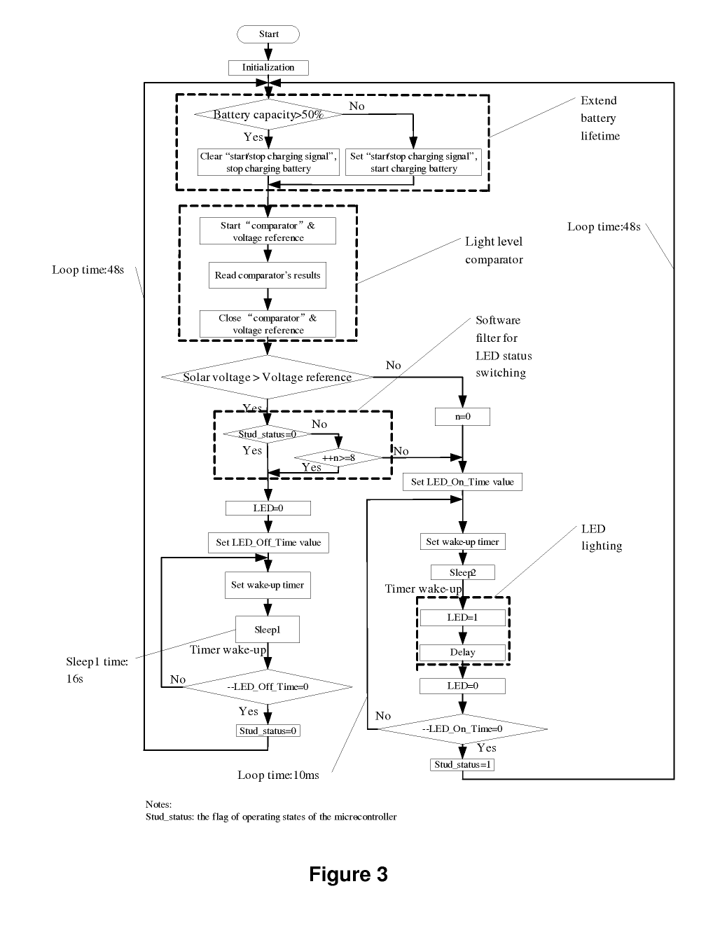

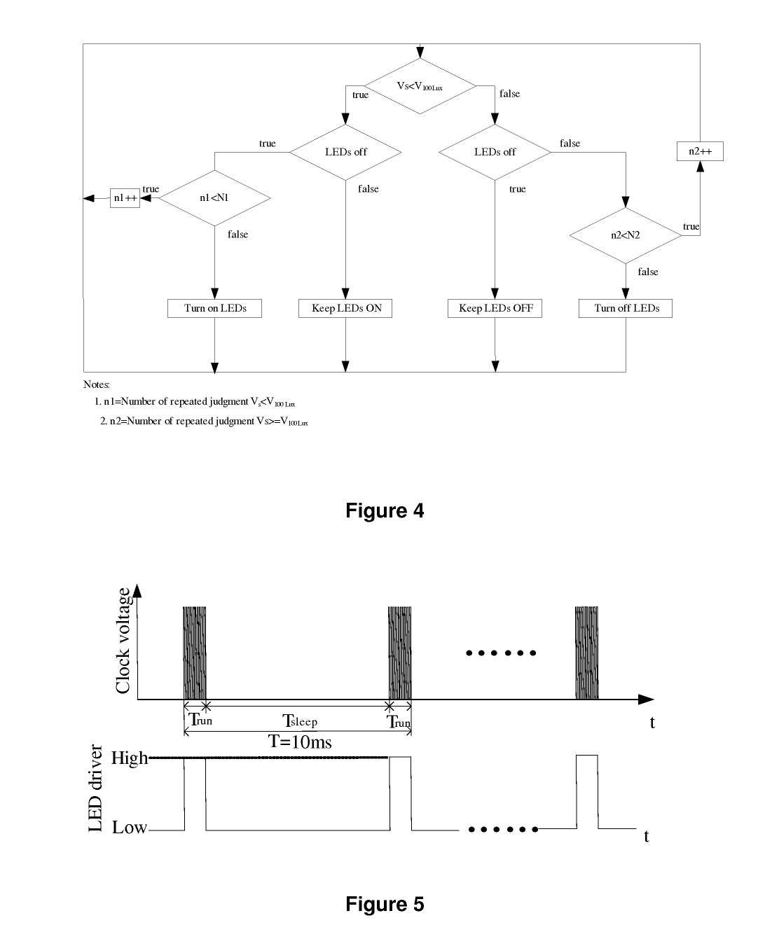

Operation of the road stud will be explained below with reference to the flow charts of FIGS. 3, 4 and 7,

### Night Operation Mode

In the night operation mode, the LED light source is operated by the micro-controller to emit light. When in this mode, the micro-controller will turn on the MOSFET switch intermittently by sending a train of power pulses to the gate terminal of the MOSFET M1, as shown in FIG. 5. The train of pulses, in the form of PWM pulses, comprises a plurality of on pulses and off pulses. The on pulses will turn on the LED such that the LED will emit visible light during the duration of the on pulse while the off pulses will turn the LED off such that no visible light will be emitted during the off pulse.

Each power pulse has a pulse period of 10 ms and a duty cycle of 5%. Each power pulse is constructed of an off pulse of 0.5 ms duration followed immediately by an off pulse of 9.5 ms duration. A pulse period of 10 ms is selected because it corresponds to a blinking frequency of 100 Hz and it is noted that the human eyes would not be able to detect blinking of flickering if the blinking frequency exceeds 50 Hz. A duty cycle of 5% means 95% saving in power consumption while a substantially 100% luminance level is still perceived by a viewer. In order to provide further power saving, the MCU is put into a low power mode, which is commonly referred to as the sleep mode, during the off pulse duration of the power train. In the sleep mode, the power consumption of the MCU is very low and can be reduced to the micro-ampere (pA) level because the system clock is stopped. The MCU will be woken up by the following wake-up events.

### Wake-up Events

The MCU of the road stud will be woken up from the sleep mode by any one of the following events:
a. Watchdog Timer time-out (if WDT was enabled)
b. Timer1 time-out (if Timer1 wake-up source was enabled)

Each wake-up cycle consists of a short wakeup mode and a long sleep mode.

During the wakeup mode the MCU checks all necessary inputs and make decisions to charge batteries, switch on/off the LED lights, etc. The sleep mode is designed to operate at a very low current to conserve energy. The chip can wake-up from sleep status by means of wake-up source, either the internal Watchdog timer (WDT), or Timer1 with an external crystal oscillator.

### Day Operation Mode

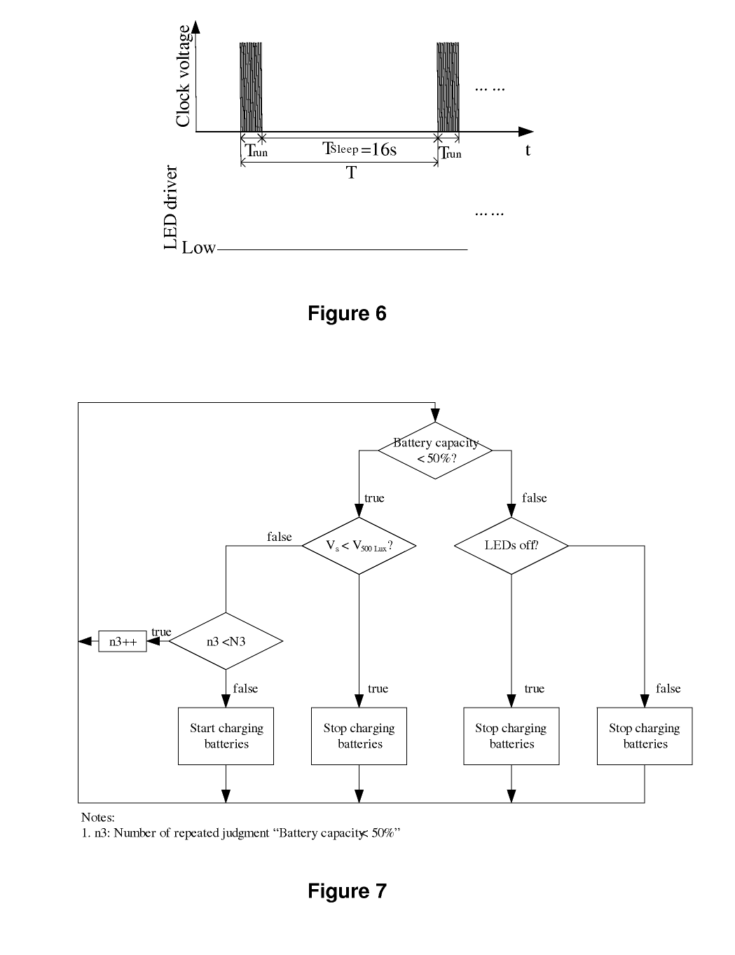

In the day operation mode, the LED does not need to emit light for driver guidance and therefore no on-pulses is required to be transmitted to the MOSFET switch M1 to supply current to turn on the LED as shown in FIG. 6. When in this mode, the MCU is set into the day or hibernation mode. In the day or hibernation mode, the sleeping time is longer than that of the night operation mode to save battery power. The sleeping time Tₛₗₑₑₚ is set to the maximum of 16 s. Therefore, the MCU will only wake up once every 16 seconds to check whether the day operation mode condition is still valid, and whether the battery should be or should not be charged.

### Determination of Day and Night Operation Modes

In order to determine whether to operate in the day operation mode or the night operation mode, and to switch into the correct operation mode as appropriate, the MCU is set to monitor the ambient luminous conditions and to changeover into the appropriate operation mode when appropriate. In deciding whether to operate in the day or night operation mode, an exemplary ambient luminous level of 100 lux is used as a criteria for changeover threshold for changing from day to night operation modes or night to day operation modes.

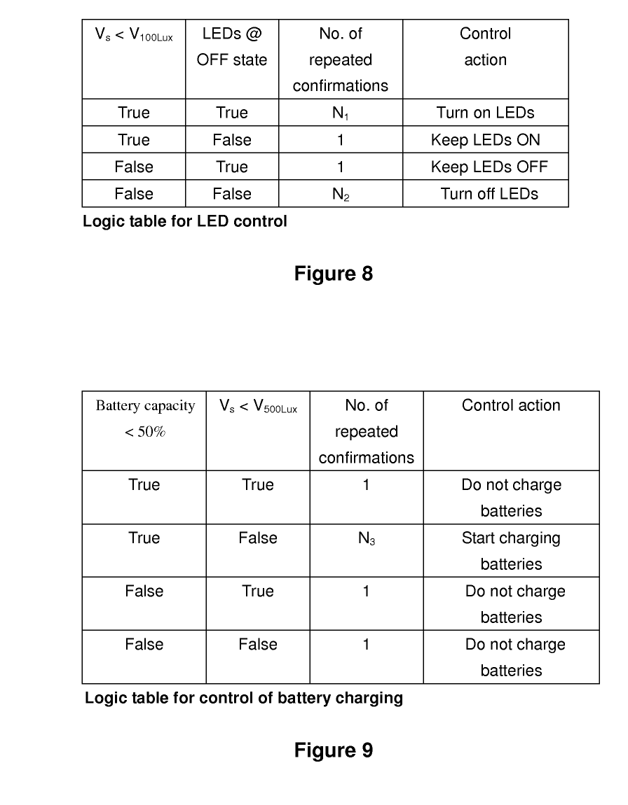

Exemplary operations of the MCU to monitor the ambient conditions and to determine whether to operate in the day or night operation modes are depicted in the flow chart of FIG. 7 and the table of FIG. 8 as follows.
a) Sampling the voltage Vₛ at the output of the solar panel. This voltage value is then compared with the calibrated solar panel output voltages which were pre-measured under standard test conditions (STC) for illumination levels of 100 lux (V_{100Lux}), and 500 lux, (V_{500Lux}) respectively. The voltage comparison may take the form of differential inputs at a voltage comparator, or through software. As power is consumed during this process, infrequent comparisons should be made while not compromising on the safety and convenience of the device users.

b) Comparing the instantaneously measured solar panel output voltage Vₛ with V_{100Lux}. In this case, 100 lux is taken to be a reference luminous threshold of turning into ‘darkness’. If Vₛ<V_{100Lux} when the road stud is in the day operation mode with the LED in OFF or non-light emitting conditions, the assumption is that the surrounding environment is dark and the LED needs to be switched on to provide lighted guidance to drivers. When this occurs, a command signal will be sent to the MCU to switch on the PWM supply for the LEDs. If Vₛ<V_{100Lux} when the LEDs are already ON, the surrounding environment is still dark and the autonomous solar device needs to continue to be switched on. If Vₛ>V_{100Lux} when the LEDs are switched off, the initial assumption is that the surrounding environment is bright enough and that the light source needs not be switched on. On the other hand, if Vₛ>V_{100Lux} when the LEDs are ON, the LEDs will not be switched off immediately as the instantaneous higher readings could be caused by transients, e.g. the headlights of a passing vehicle shining onto a solar road stud. To confirm that the increase in detected luminance level is not due to transients, repeated sampling of the solar panel output voltage for a plurality of (N) times will be taken to confirm that brighter sky or daybreak has occurred, or overcast has been taken over by sunshine. The logic state table is shown in the table of FIG. 8 where N1 and N2 are integers. N1 and N2 are user-assigned number of sampling loop cycles , and this may be regarded as software delays or filtering methods to mitigate false instructions due to transients. For example, logic state #1 refers to the case of turning on the LEDs when it is dark. However, during the sampling cycle, in the case of a solar powered road stud, a vehicle may happen to pass over the stud which results in momentarily blocking the solar road stud from the bright ambience, causing a false alarm. Hence, it is useful to ensure that this logic state is reached several times before switching on the LEDs to combat vehicular shading effect. Similarly, logic state #4 with N2 loop cycles is used to avoid turning off the LEDs due to spurious signals from the headlights of passing vehicles rather than a bright sky.

### Battery Charging Methodology

In order to extend battery life and because the life of a re-chargeable battery is largely dependent on the number of charge and discharge cycles, the MCU is configured to charge the battery using a methodology as depicted in FIG. 7 and logic of FIG. 9 as follows.
1. not to charge the battery unless the battery capacity is below 50% of the rated capacity, the 50% capacity threshold being chosen to allow for, say, 10 day operation, and
2. not to charge the battery unless the solar panel output exceeds a fine day threshold of 500 lux for a duration exceeding a predetermined time corresponding to N₃ number of repeated sampling of the solar panel output. The threshold luminous level and predetermined duration is likely a reliable factor indicating a fine sunny day to mitigate the number of short, but life reducing, charging cycles.

When the battery is being charged, it will be charged to around 90-95% of the rated capacity to ensure that the battery will not be overcharged hence shortening the battery life.

While embodiment(s) of the present invention(s) has/have been explained with reference to the examples above, the embodiments are non-limiting examples for illustrating the present invention(s) and should not be construed to limit the scope of the invention. For example, while an embodiment has been explained with reference to day and night operation modes, it should be appreciated that the terms “day” and “night” are shorthand only and does not restrict to meaning daytime or night time. For example, ‘day operation mode’ could be activated during day time during heavily fogged periods. Moreover, the choice of the luminous levels of 100 lux and 500 lux for night and day operations are only exemplary and could be replaced by other appropriate luminous levels without loss of generality. Furthermore, the duty cycle, the sleep and wake-up times, the 50% capacity threshold to start battery charging, and other parameters have also been selected on empirical bases and could be adjusted or changed as appropriate without loss of generality. Furthermore, while the present invention has been described with reference to a battery operated road stud with solar power charging, it shall be appreciated that the invention and the embodiments shall apply mutatis mutandis to other battery powered devices, such as hermetically sealed battery operated device with or without solar power charging without loss of generality.

1.-23. (canceled)

24. A battery operated device comprising a micro-controller, a battery and a light source; wherein the micro-controller is configured to operate the battery to provide a train of power pulses to the light source, and each power pulse has a characteristic pulse period and a characteristic duty cycle comprising an on-cycle and an off-cycle;
characterized in that, the micro-controller is turned on during the on-cycle and turned into a power saving or sleep mode during the off-cycle.

25. A battery operated device according to claim 24, wherein the micro-controller is configured to operate the road stud in different operation modes, and to vary the pulse period or pulse frequency and/or the duty cycle of the power pulses depending on the operation modes.

26. A battery operated device according to claim 25, wherein the different operation modes include a light emitting mode during which the light source is operated to emit light and a hibernation mode during which the light source does not emit light, wherein the micro-controller is configured to operate the light source by a train of pulse width modulated pulses.

27. A battery operated device according to claim 25, wherein the power pulse has a frequency between 50 to 200 Hertz, preferably between 50 to 120 Hertz, and more preferably at or below 100 Hertz.

28. A battery operated device according to claim 25, wherein the ratio between the duration of the on-cycle to the off-cycle is less than 20%, preferably less than 10%, and preferably at or below 5%.

29. A battery operated device comprising a micro-controller and a light source, wherein the micro-controller is configured to wake up and sleep at regular intervals, and wherein the wake up and sleep durations are different according to the operating modes of the road stud, the operating modes including a light-emitting mode during which the light source is turned on until a turn-off event occurs and a hibernation mode during which the light source is turned off until a turn-on event occurs.

30. A battery operated device according to claim 29, wherein the intervals between wake ups of the micro-controller are longer for the hibernation mode and shorter for the light-emitting mode.

31. A battery operated device comprising a micro-controller, a re-chargeable battery, a solar panel for charging the re-chargeable battery and a light source; wherein the micro-controller is configured to turn off the light source when the output level of the solar panel is above the predetermined threshold for a predetermined duration, and to turn on the light source when the output level of the solar panel is below the predetermined threshold for a predetermined duration.

32. A battery operated device according to claim 31, where the predetermined duration corresponding to the durations of typical transient events, and repeated sampling of the output level of the solar panel is taken during the predetermined duration to mitigate transient influence.

33. A battery operated device according to claim 32, wherein the duration of typical transient events for determining turning on or turning off of the light source correspond respectively to transient darkening events and transient brightening events.

34. A battery operated device according to claim 31, wherein the micro-controller is configured to turn on the light source when the output level of the solar panel is below a predetermined threshold for a first predetermined duration, the predetermined duration being longer than a transient darkening event, and to turn off the light source when the output level of the solar panel is above the predetermined threshold for a predetermined duration exceeding a transient brightening event, wherein the predetermined threshold corresponds to an illumination level of 100 lux on the solar panel.

35. A battery operated device according to claim 34, wherein the micro-controller is configured to take samples repeatedly to determine whether of the output level of the solar panel is above or below the predetermined threshold for a predetermined duration.

36. A battery operated device according to claim 34, wherein the micro-controller is configured to turn off the light source when the output level of the solar panel is above the predetermined threshold for a predetermined duration, and to turn on the light source when the output level of the solar panel is below the predetermined threshold for a predetermined duration.

37. A battery operated device according to claim 36; wherein the micro-controller is configured to begin or not to begin charging the battery depending on whether the battery capacity is below or above a predetermined battery capacity and whether the output of the solar panel exceeds a predetermined solar output threshold for a predetermined time, wherein the predetermined capacity is 50% of the rated battery capacity.

38. A battery operated device according to claim 37, wherein the predetermined solar output threshold corresponds to an illumination of 500 lux on the solar panel.

39. A battery operated device according to claim 37, wherein the micro-controller is configured to stop or cut-off charging of the battery when the instantaneous capacity of the rechargeable battery exceeds a predetermined battery capacity.

40. A battery operated device according to claim 39, wherein the road stud comprises a coulomb counter for determining the instantaneous capacity level of the rechargeable battery.

41. A battery operated device according to claim 39, wherein the micro-controller is configured to control charging of the battery by the solar panel and to operate the battery to provide power to the light source.

42. A battery operated device according to claim 24, wherein the light source comprises a light emitting diode light source.

43. A battery operated device according to claim 24, wherein the device is a road stud.
